(19) United States
(12) Patent Application Publication
(10) Pub. No.: US 2024/0134115 A1
(43) Pub. Date: Apr. 25, 2024

(54) WAVEGUIDE COUPLER FOR COUPLING LASER BEAM INTO PHOTONIC INTEGRATED CIRCUIT

(71) Applicant: Meta Platforms Technologies, LLC, Menlo Park, CA (US)

(72) Inventors: Mohit KHURANA, College Station, TX (US); John GOWARD, Oxford (GB); Rahul AGARWAL, Woodinville, WA (US); James Ronald BONAR, Redmond, WA (US)

(21) Appl. No.: 18/489,419

(22) Filed: Oct. 17, 2023

Related U.S. Application Data
(60) Provisional application No. 63/417,994, filed on Oct. 20, 2022.

(51) Int. Cl. G02B 6/12; G02B 6/122

(52) U.S. Cl. CPC G02B 6/12004; G02B 6/1223; G02B 6/1228; G02B 2006/12147

(57) ABSTRACT

An edge coupler for coupling a light beam (e.g., a laser beam) into a waveguide comprises a first waveguide section characterized by a first thickness and a first constant width, a second waveguide section physically coupled to the first waveguide section and characterized by the first thickness and a gradually decreasing width, and a third waveguide section partially overlapping with the second waveguide section at an overlap region, the third waveguide section characterized by a gradually increasing width and a second thickness different from (e.g., greater than) the first thickness. In some embodiments, a surface (e.g., the top or bottom surface) of the second waveguide section and a surface (e.g., the top or bottom surface) of the third waveguide section are on a same plane.

### CROSS-REFERENCE TO RELATED APPLICATIONS

This application claims the benefit of and priority to U.S. Provisional Application No. 63/417,994, filed Oct. 20, 2022, entitled “WAVEGUIDE COUPLER FOR COUPLING LASER BEAM INTO PHOTONIC INTEGRATED CIRCUIT,” which is herein incorporated by reference in its entirety for all purposes.

### BACKGROUND

An artificial reality system, such as a head-mounted display (HMD) or heads-up display (HUD) system, generally includes a near-eye display system in the form of a headset or a pair of glasses. The near-eye display system may be configured to present content to a user via an electronic or optic display in front of the user's eyes. The near-eye display system may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment by, for example, seeing through transparent display glasses or lenses (often referred to as optical see-through) or viewing displayed images of the surrounding environment captured by a camera (often referred to as video see-through).

A near-eye display system may include light sources (e.g., light-emitting diodes (LEDs) or lasers) and an optical system configured to form an image of a computer-generated image on an image plane. The optical system of the near-eye display system may include, for example, substrate waveguides, or photonic integrated circuits (PICs) including buried waveguides, for delivering display light from light sources to the eyebox of the near-eye display system. Some near-eye display systems may also include eye-tracking systems that can track the user's eye (e.g., gaze direction), where the eye-tracking system may include, for example, infrared LEDs or lasers and waveguides for delivering light to illuminate the user's eyes. Couplers such as edge couplers can be used to couple light from the light sources (e.g., lasers) into waveguides of PICs.

Some other optical systems, such as some optical communication systems and quantum computing systems, may also use couplers such as edge couplers to couple light from the light sources (e.g., lasers) or optical fibers into waveguides of PICs. It can be challenging to achieve a high coupling efficiency from lasers to waveguides of PICs due to, for example, the mismatch between the mode sizes of the laser beam and the waveguides.

### SUMMARY

This disclosure relates generally to edge couplers with improved coupling efficiencies for coupling light beams from lasers into waveguides in photonic integrated circuits. Various inventive embodiments are described herein, including devices, systems, methods, structures, materials, processes, and the like.

According to certain embodiments, a device may include a laser die configured to emit a laser beam (e.g., characterized by an elliptical or a circular beam shape), and a photonic integrated circuit (PIC) including an edge coupler configured to couple the laser beam into a waveguide of the PIC. The edge coupler may include a first waveguide section characterized by a first thickness and a first constant width, a second waveguide section coupled to the first waveguide section and characterized by the first thickness and a gradually decreasing width, and a third waveguide section partially overlapping with the second waveguide section at an overlap region, the third waveguide section characterized by a gradually increasing width and a second thickness different from (e.g., greater than) the first thickness.

In some embodiments, a ratio between the first constant width and the first thickness may be greater than about 10. In some embodiments, the second thickness may be at least two times of the first thickness. In some embodiments, a bottom (or top) surface of the second waveguide section and a bottom (or top) surface of the third waveguide section may be on a same plane, and the second waveguide section and the third waveguide section are merged in the overlap region. In some embodiments, a top surface of the second waveguide section and a top surface of the third waveguide section may be on a same plane, and the second waveguide section and the third waveguide section may be merged in the overlap region. In some embodiments, a bottom surface of the second waveguide section and a top surface of the third waveguide section may be on a same plane. In some embodiments, a top surface of the second waveguide section and a bottom surface of the third waveguide section may be on a same plane. In some embodiments, the device may also include a fourth waveguide section coupled to the third waveguide section, the fourth waveguide section characterized by the second thickness and a second constant width. A ratio between the second constant width and the second thickness may be, for example, less than about 2000. In some embodiments, the device may also include a refractive index matching material between the light source and the PIC.

In some embodiments, a distance between the second waveguide section and the third waveguide section is between about 0 and about 200 nm at the overlap region. In one example, the first thickness may be between about 5 nm and about 30 nm, and the first constant width may be between about 1 μm and about 10 μm. In some embodiments, the overlap region may be characterized by a length between about 1 μm and about 30 μm. In some embodiments, the second waveguide section may be characterized by a minimum width at or below about 300 nm. In some embodiments, the third waveguide section may be characterized by a minimum width at or below about 300 nm. In some embodiments, the second thickness may be between about 5 nm and about 150 nm.

According to certain embodiments, a waveguide coupler may include a first waveguide section characterized by a first thickness and a first constant width, a second waveguide section physically coupled to the first waveguide section and characterized by the first thickness and a gradually decreasing width, and a third waveguide section partially overlapping with the second waveguide section at an overlap region, the third waveguide section characterized by a gradually increasing width and a second thickness different from (e.g., greater than) the first thickness, where a surface (e.g., the top or bottom surface) of the second waveguide section and a surface (e.g., the top or bottom surface) of the third waveguide section are on a same plane.

In some embodiments of the waveguide coupler, a ratio between the first constant width and the first thickness may be greater than about 10. In some embodiments, the surface of the second waveguide section is a top surface or a bottom surface of the second waveguide section, and the surface of the third waveguide section is a top surface or a bottom surface of the third waveguide section. In some embodiments, the first thickness is between about 5 nm and about 30 nm, and the first constant width is between about 1 μm and about 10 μm. In some embodiments, the overlap region is characterized by a length between about 1 μm and about 30 μm. The third waveguide section may be characterized by a minimum width, for example, at or below about 300 nm. The second thickness may be between, for example, about 5 nm and about 150 nm. In some embodiments, the waveguide coupler may also include a fourth waveguide section physically coupled to the third waveguide section, the fourth waveguide section characterized by the second thickness and a second constant width. A ratio between the second constant width and the second thickness may be, for example, less than about 2000.

According to certain embodiments, a waveguide coupler may include a first waveguide section characterized by a first thickness and a first constant width, where the first constant width may be greater than about 10 times of the first thickness. The waveguide coupler may also include a second waveguide section physically coupled to the first waveguide section and characterized by the first thickness and a gradually decreasing width. The waveguide coupler may further include a third waveguide section partially overlapping with the second waveguide section at an overlap region, the third waveguide section characterized by a gradually increasing width and a second thickness different from (e.g., greater than) the first thickness. In some embodiments, a bottom (or top) surface of the second waveguide section and a bottom (or top) surface of the third waveguide section may be on a same plane, and the second waveguide section and the third waveguide section are merged in the overlap region.

In one example, a bottom surface of the second waveguide section and a bottom surface of the third waveguide section are on a same plane, and the second waveguide section and the third waveguide section are merged in the overlap region. In another example, a top surface of the second waveguide section and a top surface of the third waveguide section are on a same plane, and the second waveguide section and the third waveguide section are merged in the overlap region. In another example, a bottom surface of the second waveguide section and a top surface of the third waveguide section are on a same plane. In another example, a top surface of the second waveguide section and a bottom surface of the third waveguide section are on a same plane. In some embodiments of the waveguide coupler, the second thickness may be at least two times of the first thickness. In some embodiments, a distance between the second waveguide section and the third waveguide section is between about 0 and about 200 nm at the overlap region. In some embodiments, the first thickness is between about 5 nm and about 30 nm, and the first constant width is between about 1 μm and about 10 μm. In some embodiments, the overlap region is characterized by a length between about 1 μm and about 30 μm. The second waveguide section may be characterized by a minimum width, for example, at or below about 300 nm. The third waveguide section may be characterized by a minimum width, for example, at or below about 300 nm. In some embodiments, the second thickness may be between about 5 nm and about 150 nm. In some embodiments, the waveguide coupler may also include a fourth waveguide section coupled to the third waveguide section, the fourth waveguide section characterized by the second thickness and a second constant width. The second constant width may be between about 0 and about 5 μm. A ratio between the second constant width and the second thickness may be less than about 2000.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 is a cross-sectional view of an example of a near-eye display according to certain embodiments.

FIG. 5 illustrates an example of an optical see-through augmented reality system including a waveguide display according to certain embodiments.

FIG. 6 illustrates another example of a near-eye display system according to certain embodiments.

FIG. 7 illustrates another example of a near-eye display system according to certain embodiments.

FIG. 8A is a perspective view of an example of a device including a laser and a photonic integrated circuit where the laser beam from the laser is coupled into a waveguide of the photonic integrated circuit using an edge coupler according to certain embodiments.

FIG. 8B illustrates an example of mode propagation from the laser to the waveguide via the edge coupler shown in FIG. 8A according to certain embodiments.

FIGS. 9A-9C illustrate an example of a device including an edge coupler for coupling a light beam emitted by a laser into a waveguide of a photonic integrated circuit according to certain embodiments.

FIGS. 10A-10H illustrate an example of the propagation of the TE₀ mode from a laser to a waveguide through the edge coupler of FIGS. 9A-9C according to certain embodiments.

FIGS. 11A-11B illustrate another example of a device including an edge coupler for

coupling light beam emitted by a laser into a waveguide of a photonic integrated circuit according to certain embodiments.

FIGS. 12A-12B illustrate yet another example of a device including an edge coupler for coupling light beam emitted by a laser into a waveguide of a photonic integrated circuit according to certain embodiments.

FIGS. 13A-13B illustrate another example of a device including an edge coupler for coupling light beam emitted by a laser into a waveguide of a photonic integrated circuit according to certain embodiments.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

This disclosure relates generally to edge couplers with improved coupling efficiencies for coupling light beams from lasers into photonic integrated circuits. Various inventive embodiments are described herein, including devices, systems, methods, structures, materials, processes, and the like.

Many optical systems, including various augmented reality (AR) and virtual reality (VR) systems, optical communication systems, and photonic quantum computing systems, may use passive and active photonic integrated circuits (PICs) (e.g., waveguides, gratings, beam splitters, optical switches) and other optical and electrical components, such as light sources (e.g., lasers or light emitting diodes) and optical fibers. Different components in the optical system may have similar or vastly different mode shapes and sizes. For example, some laser beams may be polarized or at least partially polarized beams with elliptical shapes, while waveguides in photonic integrated circuits may have mode shapes and/or sizes that may not match the laser beams. Therefore, coupling light from one component (e.g., the laser) to another component (e.g., a buried waveguide) may have a low coupling efficiency due to the mode mismatch and other losses (e.g., due to reflections at interfaces between different media). As such, the efficiency of the system that includes different components on the optical path may be low and the power consumption of the system may be high.

According to certain embodiments, an edge coupler including two oppositely tapered and partially overlapped waveguides may be used to couple light from a laser into a photonic integrated circuit with improved coupling efficiency. One of the two partially overlapped waveguides may interface with the laser and may have a large width to thickness ratio to better match with the light beam emitted by the laser. The two partially overlapped waveguides may have different thicknesses, and may be in contact with each other or may be at a certain distance from each other at the overlapped region. For example, in some embodiments, the two partially overlapped waveguides may have surfaces (e.g., top or bottom surfaces) on a same plane (e.g., a same horizontal plane). In some embodiments, a top surface of one waveguide of the two partially overlapped waveguides may be in contact with a bottom surface of the other waveguide of the two partially overlapped waveguides at the overlapped region.

The edge coupler disclosed herein may be used to couple visible light or non-visible light (e.g., infrared light) from lasers to photonic integrated circuits with coupling efficiencies greater than, for example, about 80% or higher. Various materials can be used as the waveguide cores of the edge couplers. For example, the first section of the edge coupler with a lower thickness may include SiN, Al₂O₃, SiON, or any other suitable materials. The second section of the edge coupler with a higher thickness may include SiN, LiNI, AN, or any other suitable materials. Index-matching material may be used between the lasers and the photonic integrated circuits to reduce the reflection, for example, from about 5% to below 1%, reduce the total insertion loss by, for example, 5%, and reduce some challenges associated with imperfect facets. The edge couplers disclosed herein can be used for passive and/or active alignment of laser dies with PICs, and can be compatible with self-aligning wafer-level laser to PIC bonding techniques such as flip-chip bonding.

The edge coupler structure disclosed herein may have high tolerance of the relative position of the waveguides. For example, an offset about 150 nm from the desired location along the light propagation or longitudinal direction (e.g., the z direction) may cause less than about 1% additional insertion loss. An offset about 150 nm from the desired location in the horizontal direction (e.g., the x direction) may cause less than about 8% additional insertion loss. An offset about 100 nm from the desired location in the horizontal direction (e.g., the x direction) may cause less than about 4% additional insertion loss.

The couplers described herein may be used in conjunction with various technologies, such as an artificial reality system. An artificial reality system, such as a head-mounted display (HMD) or heads-up display (HUD) system, generally includes a display configured to present artificial images that depict objects in a virtual environment. The display may present virtual objects or combine images of real objects with virtual objects, as in virtual reality (VR), augmented reality (AR), or mixed reality (MR) applications. For example, in an AR system, a user may view both displayed images of virtual objects (e.g., computer-generated images (CGIs)) and the surrounding environment by, for example, seeing through transparent display glasses or lenses (often referred to as optical see-through) or viewing displayed images of the surrounding environment captured by a camera (often referred to as video see-through).

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

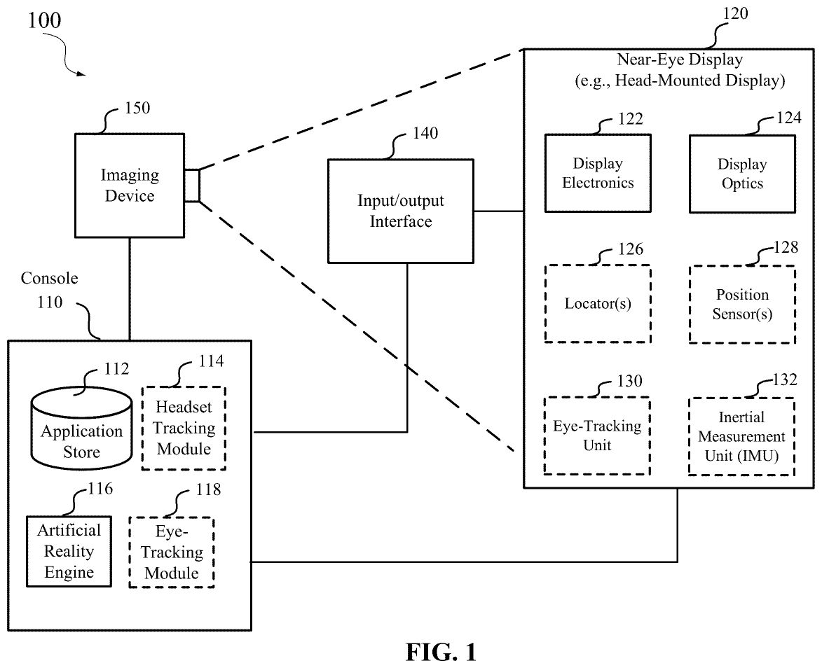

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

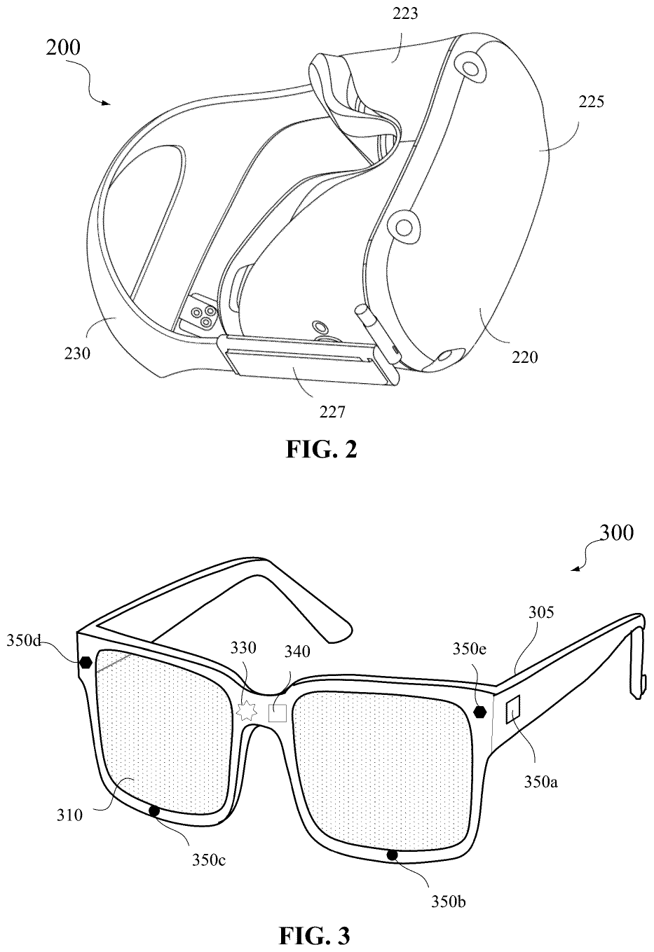

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an anti-reflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be an LED, a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 10 nm to about 380 nm), in another portion of the electromagnetic spectrum, or in any combination of portions of the electromagnetic spectrum.

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 100 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking module 114, an artificial reality engine 116, and an eye-tracking module 118. Some embodiments of console 110 may include different or additional modules than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the modules of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking module 114 may track movements of near-eye display 120 using slow calibration information from external imaging device 150. For example, headset tracking module 114 may determine positions of a reference point of near-eye display 120 using observed locators from the slow calibration information and a model of near-eye display 120. Headset tracking module 114 may also determine positions of a reference point of near-eye display 120 using position information from the fast calibration information. Additionally, in some embodiments, headset tracking module 114 may use portions of the fast calibration information, the slow calibration information, or any combination thereof, to predict a future location of near-eye display 120. Headset tracking module 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking module 114. Artificial reality engine 116 may also receive estimated eye position and orientation information from eye-tracking module 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking module 118 may receive eye-tracking data from eye-tracking unit 130 and

determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking module 118 to determine the eye's orientation more accurately.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a μLED display, an AMOLED, a TOLED, some other display, or any combination thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. Camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

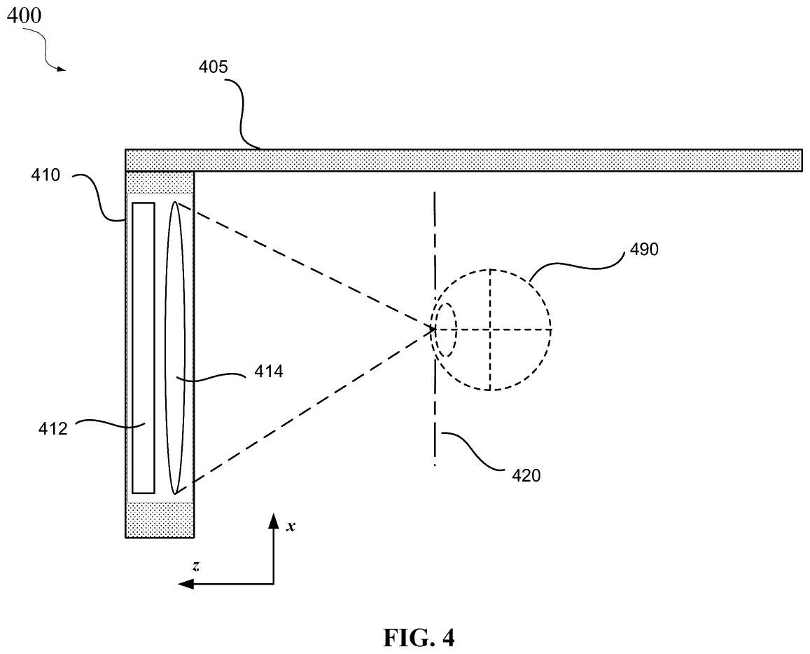

FIG. 4 is a cross-sectional view of an example of a near-eye display 400 according to certain embodiments. Near-eye display 400 may include at least one display assembly 410. Display assembly 410 may be configured to direct image light (e.g., display light) to an eyebox located at an exit pupil 420 and to user's eye 490. It is noted that, even though FIG. 4 and other figures in the present disclosure show an eye of a user of the near-eye display for illustration purposes, the eye of the user is not a part of the corresponding near-eye display.

As HMD device 200 and near-eye display 300, near-eye display 400 may include a frame 405 and display assembly 410 that may include a display 412 and/or display optics 414 coupled to or embedded in frame 405. As described above, display 412 may display images to the user electrically (e.g., using LCDs, LEDs, OLEDs) or optically (e.g., using a waveguide display and optical couplers) according to data received from a processing unit, such as console 110. In some embodiments, display 412 may include a display panel that includes pixels made of LCDs, LEDs, OLEDs, and the like. Display 412 may include sub-pixels to emit light of a predominant color, such as red, green, blue, white, or yellow. In some embodiments, display assembly 410 may include a stack of one or more waveguide displays including, but not restricted to, a stacked waveguide display, a varifocal waveguide display, and the like. The stacked waveguide display may be a polychromatic display (e.g., a red-green-blue (RGB) display) created by stacking waveguide displays whose respective monochromatic sources are of different colors.

Display optics 414 may be similar to display optics 124 and may display image content optically (e.g., using optical waveguides and optical couplers), correct optical errors associated with the image light, combine images of virtual objects and real objects, and present the corrected image light to exit pupil 420 of near-eye display 400, where the user's eye 490 may be located. In some embodiments, display optics 414 may also relay the images to create virtual images that appear to be away from display 412 and further than just a few centimeters away from the eyes of the user. For example, display optics 414 may collimate the image source to create a virtual image that may appear to be far away (e.g., greater than about 0.3 m, such as about 0.5 m, 1 m, or 3 m away) and convert spatial information of the displayed virtual objects into angular information. In some embodiments, display optics 414 may also magnify the source image to make the image appear larger than the actual size of the source image. More details of display 412 and display optics 414 are described below.

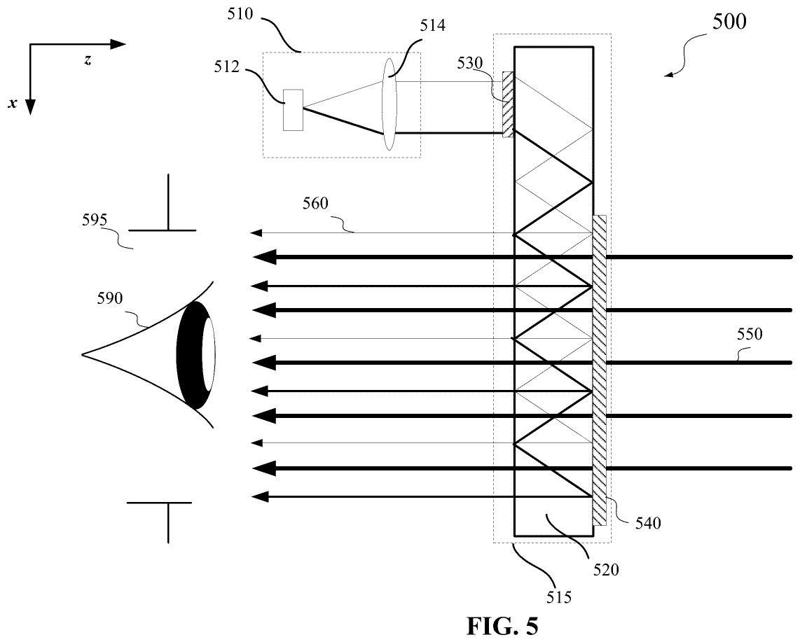

FIG. 5 illustrates an example of an optical see-through augmented reality system 500 including a waveguide display according to certain embodiments. Augmented reality system 500 may be another example of near-eye display 400, and may include a projector 510 and a combiner 515. Projector 510 may include a light source or image source 512 and projector optics 514. In some embodiments, image source 512 may include a plurality of pixels that displays virtual objects, such as an LCD display panel or an LED display panel. For example, in some embodiments, light source or image source 512 may include one or more micro-LED devices, such as micro-OLED devices or semiconductor micro-LED devices. In some embodiments, image source 512 may include a plurality of light sources (e.g., a two-dimensional array of micro-LEDs), each emitting a monochromatic image light corresponding to a primary color (e.g., red, green, or blue). In some embodiments, image source 512 may include three two-dimensional arrays of micro-LEDs, where each two-dimensional array of micro-LEDs may include micro-LEDs configured to emit light of a primary color (e.g., red, green, or blue). In some embodiments, image source 512 may include a coherent or partially coherent light source (e.g., a laser) and an optical pattern generator, such as a spatial light modulator.

Projector optics 514 may include one or more optical components that can condition the light from image source 512, such as expanding, collimating, scanning, or projecting light from image source 512 to combiner 515. The one or more optical components may include, for example, one or more solid lenses, liquid lenses, minors, apertures, and/or gratings. In some embodiments, image source 512 may include one or more two-dimensional arrays of micro-LEDs, and projector optics 514 may include a lens assembly. In some embodiments, image source 512 may include one or more one-dimensional arrays or elongated two-dimensional arrays of micro-LEDs, and projector optics 514 may include one or more one-dimensional scanners (e.g., micro-mirrors or prisms) configured to scan light emitted by the one-dimensional arrays or elongated two-dimensional arrays of micro-LEDs to generate image frames. In some embodiments, projector optics 514 may include a liquid lens (e.g., a liquid crystal lens) with a plurality of electrodes that allows scanning of light from image source 512.

Combiner 515 may include an input coupler 530 for coupling light from projector 510 into a substrate 520 of combiner 515. Input coupler 530 may include, for example, a diffractive optical element (DOE) (e.g., a volume holographic grating, a surface-relief grating, a PBP grating, or a PVH grating), a slanted surface of substrate 520, or a refractive coupler (e.g., a wedge or a prism). For example, input coupler 530 may include a transmissive volume Bragg grating (e.g., on a surface of substrate 520 facing projector 510) or a reflective volume Bragg grating (e.g., on a surface of substrate 520 opposing projector 510). Input coupler 530 may have a coupling efficiency of greater than 30%, 50%, 75%, 90%, or higher for visible light. Light coupled into substrate 520 may propagate within substrate 520 through, for example, total internal reflection (TIR). In some embodiments, substrate 520 may be in the form of a lens of a pair of eyeglasses. Substrate 520 may have a flat or a curved surface, and may include one or more types of dielectric materials, such as glass, quartz, plastic, polymer, poly(methyl methacrylate) (PMMA), crystal, or ceramic. A thickness of the substrate may range from, for example, less than about 1 mm to about 10 mm or more. Substrate 520 may be transparent to visible light.

Substrate 520 may include or may be coupled to a plurality of output couplers 540. Each output coupler 540 may be configured to extract at least a portion of the light guided by and propagating within substrate 520 out of substrate 520, and direct the extracted light 560 towards an eyebox 595 where an eye 590 of the user of augmented reality system 500 may be located when augmented reality system 500 is in use. The plurality of output couplers 540 may replicate the exit pupil to increase the size of eyebox 595 such that the displayed image may be visible in a larger area. As input coupler 530, output couplers 540 may include grating couplers (e.g., volume holographic gratings or surface-relief gratings), other diffraction optical elements (DOEs), prisms, partial reflectors (e.g., transflective minors), and the like. For example, output couplers 540 may include reflective volume Bragg gratings, transmissive volume Bragg gratings, or PVHs. Output couplers 540 may have different coupling (e.g., diffraction) efficiencies at different locations such that the intensities of the light beams coupled out of substrate 520 at different locations may be about the same. Substrate 520 and output couplers 540 may also allow light 550 from the environment in front of combiner 515 to pass through with little or no loss. For example, in some implementations, output couplers 540 may have a very low diffraction efficiency for light 550 such that light 550 may be refracted or otherwise pass through output couplers 540 with little loss, and may have a higher intensity than extracted light 560. As a result, the user may be able to view combined images of the environment in front of combiner 515 and images of virtual objects projected by projector 510.

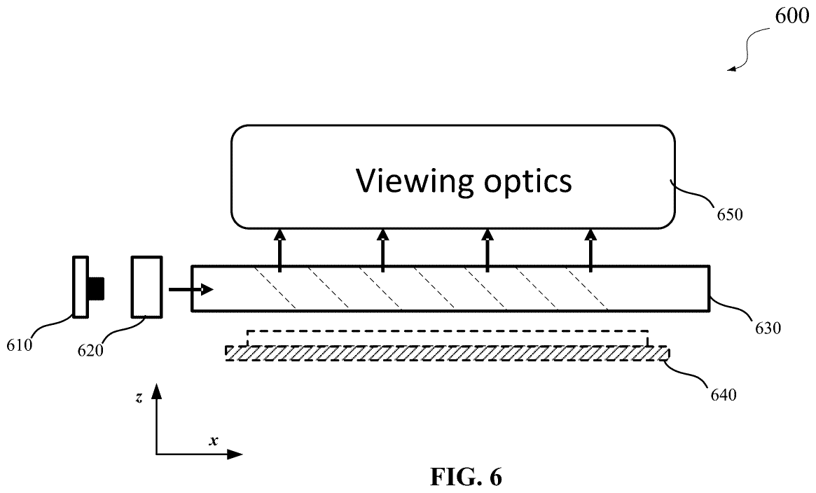

FIG. 6 illustrates another example of a near-eye display system 600 according to certain embodiments. Near-eye display system 600 may include a light source 610 (e.g., one or more lasers or LEDs) that may emit light in one or more colors (e.g., red, blue, and green light). The emitted light may be optionally conditioned (e.g., polarized, collimated, focused, and/or magnified) by conditioning optics 620 and sent to a waveguide combiner 630. Waveguide combiner 630 may include one or more input couplers that may couple light from light source 610 into waveguide combiner 630. In some embodiments, waveguide combiner 630 may include one or more waveguide layers that distribute the in-coupled light into different areas of waveguide combiner 630. Waveguide combiner 630 may also include one or more output couplers that may couple light out of waveguide combiner 630 to view optics 650(e.g., including one or more lenses), or may couple light out of waveguide combiner 630 to illuminate a micro-display device 640 (e.g., a liquid crystal-on-silicon (LCoS) display), which may modulate and reflect the illumination light back to waveguide combiner 630. In some embodiments, waveguide combiner 630 may selectively transmit polarized light towards view optics 650 for displaying to the user. Waveguide combiner 630 may also include, for example, an array of beam splitters, a one-dimensional or two-dimensional pupil expansion structure (e.g., a set of gratings), and the like. Couplers for coupling light into or out of waveguide combiner 630 may include, for example, edge couplers, surface-relief gratings, volume Bragg gratings, polarization volume gratings, or the like. The couplers may be polarization sensitive or may not be polarization sensitive. In general, it is desirable that the coupler be polarization sensitive for coupling a laser beam into a waveguide with a high coupling efficiency and high polarization extinction ratio.

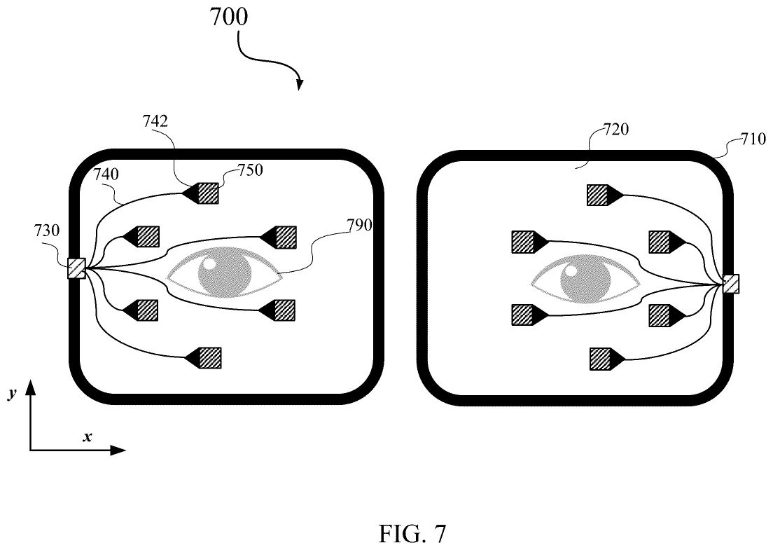

FIG. 7 illustrates another example of a near-eye display 700 according to certain

embodiments. Near-eye display 700 may include a frame 710 and a substrate 720 for each eye. Substrate 720 may be held by frame 710, and may include any suitable material, such as glass, plastic, polymer, PMMA, silica, SiC, sapphire, ceramic, crystal (such as lithium niobate or tellurium dioxide), a semiconductor material, and the like. Substrate 720 may be transparent to visible light and/or infrared (IR) light. Substrate 720 may have a flat or curved broadside surface.

Near-eye display 700 may include one or more light sources 730 that may emit coherent or noncoherent light, such as a light emitting diode (LED), a micro-LED, a resonant cavity micro-LED, a Vertical External-Cavity Surface-Emitting Laser (VECSEL), a Vertical-Cavity Surface-Emitting Laser (VCSEL), a superluminescent diode (SLED), a tunable laser, a quantum dot laser, an edge emitting laser, or a laser diode. Light source 730 may emit visible light, or may emit light with wavelengths outside of the visible spectrum (e.g., between about 380 nm and about 750 nm), for example, for eye-tracking. For example, in some embodiments, light source 730 may emit light in the IR band (e.g., between about 750 nm and about 1700 nm). Light source 730 may be attached to frame 710 or may be embedded in frame 710 or substrate 720. Light source 730 may be controlled by a controller, a processor, or another control system (not shown in FIG. 7) within or coupled to near-eye display 700.

Waveguides 740 may be formed in or on substrate 720 and may include any suitable type of waveguides, such as buried channel waveguides, ridge waveguides, microstrip waveguides, or stripline waveguides. In some embodiments, waveguides 740 may include a core layer and cladding layers, where the core layer may include, for example, SiN, Al₂O₃, SiON, or AlN, and may have a refractive index greater than the refractive indices of the cladding layers (e.g., including SiO₂). Light emitted by light source 730 may be coupled into waveguides 740 through, for example, an edge coupler including an adiabatically tapered waveguide or a grating coupler. Waveguides 740 may include one or more splitters that split the light coupled into waveguides 740 into two or more beams propagating in two or more waveguides 740 to different regions of substrate 720. The two or more beams may have substantially the same amplitude. In some embodiments, each waveguide 740 may include a taper structure 742 that may expand the beam at an end section of each waveguide 740. A grating coupler 750 may be formed at taper structure 742 of each waveguide 740 and may be used to couple the light beam guided by waveguide 740 out of waveguide 740 towards a user's eye 790.

In some embodiments, light beams coupled out of waveguides 740 by grating couplers 750 may include display light of a displayed image. The different light beams coupled out of different waveguides 740 at different regions of substrate 720 may replicate the exit pupil at the eyebox to form an aggerated exit pupil and expand the eyebox in one or two dimensions. In some 30 embodiments, the light beam coupled out of a waveguide 740 by a grating coupler 750 may be a narrow IR light beam that has a small divergence angle, and may form a glint on the user's eye for eye illumination in eye tracking. In some embodiments, two light beams coupled out of two waveguides 740 by two grating couplers 750 and propagating towards user's eye 790 may each have a large solid angle and thus may have an overlapped area on the user's eye to form interferometric fringe patterns on the user's eye for eye-tracking.

The light beam emitted by light source 730 may be polarized, and may have an elliptical shape. However, the waveguides may support guided modes having quite different optical field shapes and/or sizes. A large mismatch between the optical field of the laser beam and the optical field of the guided modes of the waveguides may cause a large coupling loss at the interface between a laser die and the waveguide, and thus may reduce the efficiency of the system and increase the power consumption of the system. Single layer waveguide couplers, such as inverse taper, horn taper, and multi-tips, may not be suitable for coupling elliptical laser beam, and may have high insertion loss because waveguides in the PIC may need to have high thicknesses that may be much thicker than 10 nm.

According to certain embodiments, an edge coupler including two oppositely tapered and partially overlapped waveguides may be used to couple light from a laser into a photonic integrated circuit with improved coupling efficiency. One of the two partially overlapped waveguides may interface with the laser and may have a large width-to-thickness (or height) ratio to better match with the light beam emitted by the laser. The two partially overlapped waveguides may have different thicknesses (heights), and may be in contact with each other or may be at a certain distance from each other at the overlapped region. For example, in some embodiments, the two partially overlapped waveguides may have surfaces (e.g., top or bottom surfaces) on a same plane (e.g., a same horizontal plane). In some embodiments, a top surface of one waveguide of the two partially overlapped waveguides may be in contact with a bottom surface of the other waveguide of the two partially overlapped waveguides at the overlapped region.

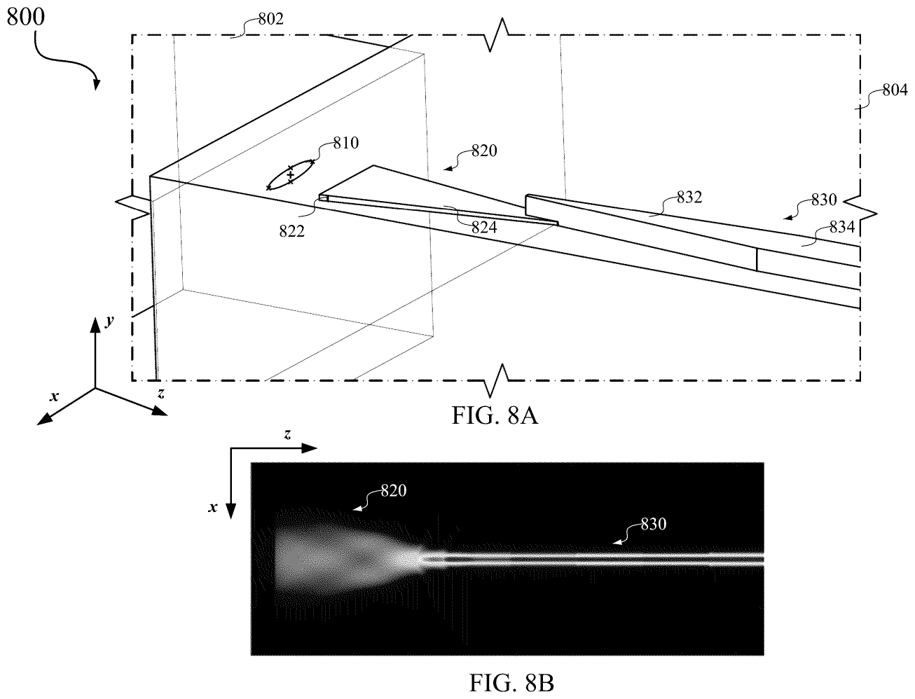

FIG. 8A is a perspective view of an example of a device 800 including a laser die 802 and a photonic integrated circuit 804, where an elliptical laser beam 810 from laser die 802 may be coupled into a waveguide of photonic integrated circuit 804 using an edge coupler disclosed herein according to certain embodiments. As illustrated, laser beam 810 may have an elliptical shape instead of a circular shape. For example, the beam width in the x direction may be much larger than the beam width in the y direction. Laser die 802 may be positioned in close proximity to PIC 804, for example, with a distance about 0 to about 10 μm (measured in the z direction). In some embodiments, the region between laser die 802 and PIC 804 may be filled with an index-matching material (e.g., SiO₂ or another dielectric material) that may have a refractive index greater than 1, and thus may reduce Fresnel reflections at interfaces between different media, such as at the output surface of laser die 802 and an edge surface of PIC 804. For example, the index-matching material may reduce the reflection from about 5% to below 1% and reduce the insertion loss by 5%. In some embodiments, edge surfaces of laser die 802 and PIC 804 may be coated with an antireflection coating (ARC) layer to further reduce losses caused by reflections.

PIC 804 may include one or more waveguide core layers (e.g., including SiN cores or another high-index material that may be transparent to visible light and/or infrared lights). The waveguide core layers may be surrounded by cladding layers (e.g., including SiO₂) that have lower refractive indices than the waveguide cores. Both the waveguide core layers and the cladding layers may be substantially transparent to laser beam 810. In the illustrated example, PIC 804 may include an edge coupler for coupling laser beam 810 into a waveguide. The edge coupler may include two sections, where the waveguide cores of the two sections may have different thicknesses (measured in the y direction) and may include oppositely tapered portions. The bottom surfaces (in y direction) of the two sections may be on a same plane (e.g., an x-z plane), and the two sections may have some overlap in the z direction (e.g., when viewed in the x or y direction).

A first section 820 of the edge coupler is at an edge of PIC 804 and may interface with laser die 802. First section 820 may have a first region 822 that has a constant width (e.g., about 1-10 μm measured in the x direction), and a second region 824 the width of which may be gradually (linearly or nonlinearly) tapered down in the z direction. First region 822 may have a large width-to-thickness ratio such that it may match the elliptical beam shape of laser beam 810. First region 822 may have a length (measured in the z direction) about 0 to 20 μm, and second region 824 may have a length about, for example, 5-50 μm. First region 822 and second region 824 of first section 820 may have the same thickness (e.g., about 5-30 nm, such as about 10 nm). Therefore, first region 822 may have a large width-to-thickness ratio (e.g., >10, >50, or >100).

First region 822 may have a certain length such that dicing PICs from a wafer may not cut into second region 824.

A second section 830 of the edge coupler may couple to a waveguide of PIC 804, and may include a first region 832, the width of which may be about 0-300 nm at the tip and may gradually increase in the z direction (tapered in the -z direction) to the width of the waveguide of PIC 804. First region 832 of second section 830 may have a length (measured in the z direction), for example, about 10-100 μm. Second section 830 of the edge coupler may include a second portion 834, which may have a constant width (e.g., the width of the waveguide) and may be a part of the waveguide. Second section 830 may have a thickness (e.g., about 5-150 nm) that is greater than the thickness of first section 820 (e.g., about 5-30 nm). As illustrated, second region 824 of first section 820 and first region 832 of second section 830 may taper in opposite directions, and may have an overlap region, for example, about 1-30 μm in the z direction. The bottom surfaces of first section 820 and second section 830 may be on a same plane (e.g., an x-z plane).

FIG. 8B illustrates an example of the propagation of a guided mode from the laser to the waveguide via the edge coupler shown in FIG. 8A according to certain embodiments. FIG. 8B shows the intensity of the optical field at different regions of the edge coupler. As shown in FIG. 8B, the optical field may have a large size when entering first region 822 of first section 820 of the edge coupler. The size of the optical field of the guided mode in second region 824 of first section 820 of the edge coupler may gradually reduce as the light beam propagates in second region 824 along the z direction. The guided mode may be gradually coupled from first section 820 into second section 830 at the overlap region, and may be mostly confined within the waveguide core in second section 830 and transported to other waveguides in PIC 804.

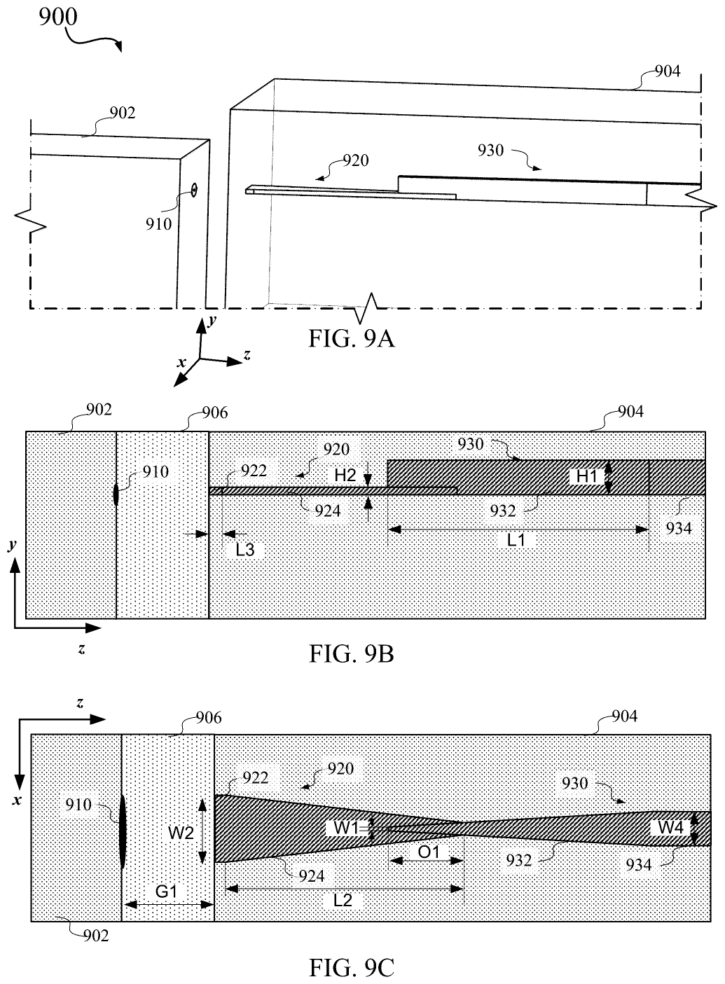

FIGS. 9A-9C illustrate an example of a device 900 including an edge coupler for coupling light beam emitted by a laser into a waveguide of a photonic integrated circuit according to certain embodiments. Device 900 may be an example of device 800. FIG. 9A is a perspective view of device 900, FIG. 9B is a vertical cross-sectional view of device 900, and FIG. 9C is a horizontal cross-sectional view of device 900. Device 900 may include a laser die 902 that has a laser emission region 910, where the emitted laser beam may have an elliptical shape. In the illustrated example, the beam width in the x direction may be much larger than the beam width in the y direction. Laser die 902 may be in close proximity to PIC 904, for example, with a distance G1 equal to or less than about 10 μm in the z direction. The region between laser die 902 and PIC 904 may be filled with an index-matching material 906 (e.g., SiO₂ or another dielectric material) that may have a refractive index greater than 1.0, such as greater than about 1.5 or higher, and thus may help to reduce Fresnel reflections at interfaces between different media, such as the light emitting surface of laser die 902 and the edge surface of PIC 904. For example, index-matching material 906 may reduce the reflection from about 5% to below 1% and reduce the insertion loss by 5%. In some embodiments, light emitting surfaces of laser die 902 and edge surface of PIC 904 may be coated with an ARC layer to further reduce losses caused by reflections.

PIC 904 may include one or more waveguide core layers (e.g., including SiN cores) surrounded by cladding layers (e.g., including SiO₂) that have lower refractive indices than the waveguide cores. Both the waveguide core layers and the cladding layers may be substantially transparent to the laser beam emitted by laser die 902, which may be visible light or invisible light, such as infrared light. In the illustrated example, PIC 904 may include an edge coupler for coupling the laser beam into a waveguide of PIC 904. The edge coupler may include two sections, where the waveguide cores of the two sections may have different thicknesses (measured in the y direction) and may include oppositely tapered regions. The bottom surfaces (in y direction) of the two sections may be on a same plane (e.g., an x-z plane), and the two sections may have some overlap in the z direction (e.g., viewed in x or y direction).

A first section 920 of the edge coupler is at an edge of PIC 904. First section 920 may have a first region 922 that has a constant width W2 (e.g., about 1-10 μm measured in the x direction), and a second region 924 the width of which may be gradually (linearly or nonlinearly) tapered down in the z direction. First region 922 may have a low thickness H2, for example, about 5-30 nm, such as about 10 nm. Therefore, first region 922 may have a large width-to-thickness ratio (e.g., >10, >50, or >100), such that it may better match the elliptical beam shape of the laser beam. First region 922 may have a length L3 (measured in the z direction), for example, about 0 to 20 μm. Second region 924 may have a length L2, for example, about 5-50 μm. First region 922 and second region 924 may have the same thickness (or height), for example, about 5-30 nm, such as about 10 nm.

A second section 930 of the edge coupler may couple to a waveguide of PIC 904. Second section 930 may include a first region 932, the width W1 of which may be about 0-300 nm at the tip and may gradually increase in the z direction (tapered in the −z direction) to the width of the waveguide of PIC 904. First region 932 of second section 930 may have a length L1 (measured in the z direction), for example, about 10-100 μm. Second section 930 of the edge coupler may include a second portion 934, which may have a constant width (e.g., the width of the waveguide, such as between about 0-5 82 m) and may be a part of the waveguide. Second section 930 may have a thickness (or height) H1 that is greater than the thickness H2 of first section 920, such as about 5-150 nm (e.g., about 50 nm). As illustrated, second region 924 of first section 920 and first region 932 of second section 930 may taper in opposite directions, and may have an overlap region O1 that is about, for example, 1-30 μm long in the z direction. First section 920 and second section 930 may include the same material and may merge in overlap region O1. Because the narrow tip of second region 924 of first section 920 is merged with first region 932 of second section 930, the width of the narrow tip of second region 924 of first section 920 may not be a constraint in fabrication.

In some embodiments, the edge coupler may be formed by, for example, depositing and patterning a first waveguide layer, such as a SiN layer with a thickness the same as the thickness of first section 920 (e.g., about 5-30 nm, such as about 10 nm); depositing and planarizing a first oxide layer; depositing and patterning a second waveguide layer such as a SiN layer with a thickness equal to the difference between the thickness of second section 930 and the thickness of first section 920 of the edge coupler; and depositing a second oxide layer to cover the second waveguide layer.

In some embodiments, the edge coupler may be formed by, for example, depositing and patterning a first oxide layer with a thickness that is about the same as the thickness of first section 920, such as about 5-30 nm (e.g., about 10 nm); depositing a first waveguide layer (e.g., a SiN layer) in apertures formed in the first oxide layer; depositing and patterning a second oxide layer with a thickness equal to the difference between the thickness of second section 930 and the thickness of first section 920 of the edge coupler; and then depositing a second waveguide layer, such as a second SiN layer, in apertures of the second oxide layer.

In one example, first section 920 may include a SiN layer with a thickness H2 about 10 nm, and second section 930 may include a SiN layer with a thickness H1 about 50 nm. When the minimum width that can be achieved by the fabrication process is about 130 nm and the feature size is about 130 nm, a coupling efficiency up to about 85% may be achieved using the edge coupler disclosed herein.

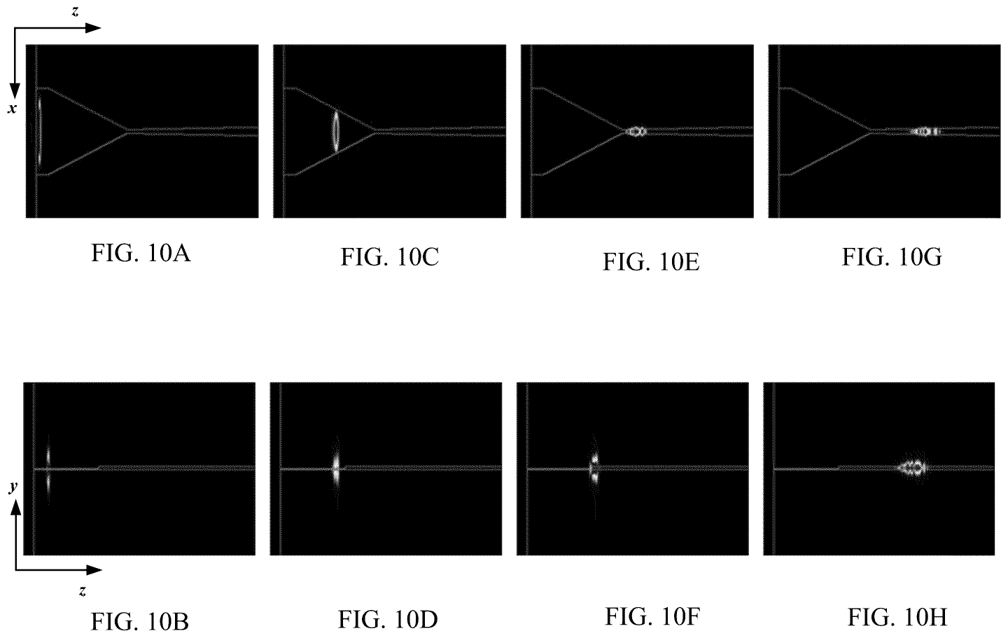

FIGS. 10A-10H illustrate examples of the propagation of the TE₀ mode from laser die 902 to a waveguide in PIC 904 through the edge coupler of FIGS. 9A-9C according to certain embodiments. FIGS. 10A and 10B show the top view and side view, respectively, of an example of the TE₀ mode in first region 922 of first section 920 of the edge coupler. FIGS. 10C and 10D show the top view and side view, respectively, of an example of the TE₀ mode in second region 924 of first section 920 of the edge coupler. FIGS. 10E and 10F show the top view and the side view, respectively, of an example of the TE₀ mode at overlap region O1. FIGS. 10G and 10H show the top view and the side view of an example of the TE₀ mode at first region 932 of the second section 930 of the edge coupler.

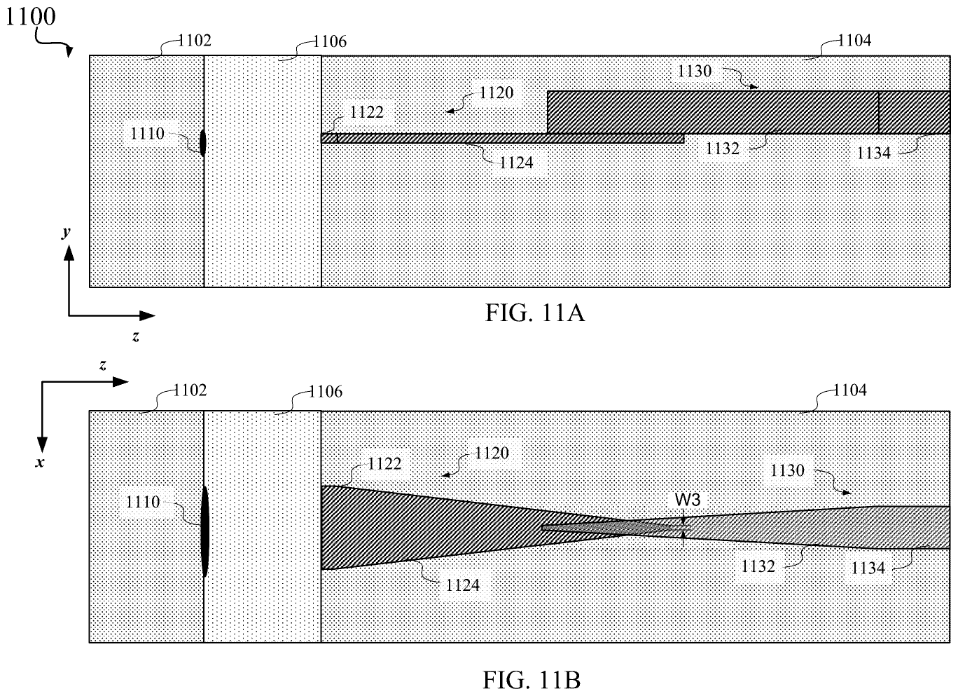

FIGS. 11A-11B illustrate another example of a device 1100 including an edge coupler for coupling light beam emitted by a laser into a waveguide of a photonic integrated circuit according to certain embodiments. FIG. 11A is a vertical cross-sectional view of device 1100, and FIG. 11B is a horizontal cross-sectional view of device 1100. Device 1100 may include a laser die 1102 that has a laser emission region 1110, where the emitted laser beam may have an elliptical shape. In the illustrated example, the beam width in the x direction may be much larger than the beam width in the y direction. Laser die 1102 may be in close proximity to PIC 1104, for example, with a distance equal to or less than about 10 μm in the z direction. The region between laser die 1102 and PIC 1104 may be filled with an index-matching material 1106 (e.g., SiO₂ or another dielectric material) that may have a refractive index greater than 1.0, such as greater than about 1.5 or higher, and thus may help to reduce Fresnel reflections at interfaces between different media. In some embodiments, the light emitting surface of laser die 1102 and the edge surface of PIC 1104 may be coated with an ARC layer to further reduce losses caused by reflections.

PIC 1104 may include one or more waveguide core layers (e.g., including SiN cores) surrounded by cladding layers (e.g., including SiO₂) that have lower refractive indices than the waveguide cores. Both the waveguide core layers and the cladding layers may be substantially transparent to the laser beam emitted by laser die 1102, which may be visible light or invisible light, such as infrared light. In the illustrated example, PIC 1104 may include an edge coupler for coupling the laser beam into a waveguide. The edge coupler may include two sections, where the waveguide cores of the two sections may have different thicknesses (measured in the y direction) and may include oppositely tapered regions. The bottom surface (in y direction) of the second section and the top surface of the first section may be on a same plane (e.g., an x-z plane), and the two sections may have some overlap in the z direction.

A first section 1120 of the edge coupler is at an edge of PIC 1104. First section 1120 may include a first region 1122 that has a constant width (e.g., about 1-10 μm measured in the x direction), and a second region 1124 the width of which may be gradually (linearly or nonlinearly) tapered down in the z direction. First region 1122 may have a low thickness, for example, about 5-30 nm, such as about 10 nm. Therefore, first region 1122 may have a large width-to-thickness ratio, such that it may better match the elliptical beam shape of the laser beam. First region 1122 may have a length (measured in the z direction), for example, about 0 to 20 μm, and second region 1124 may have a length, for example, about 5-50 μm. The end of second region 1124 of first section 1120 may have a width W3 about 0 to about 300 nm. First region 1122 and second region 1124 may have the same thickness, for example, about 5-30 nm, such as about 10 nm.

A second section 1130 of the edge coupler that couples to a waveguide of PIC 1104 may include a first region 1132, the width of which may be about 0-300 nm at the tip and may gradually increase in the z direction (tapered in the −z direction) to the width of the waveguide of PIC 1104. First region 1132 of second section 1130 may have a length (measured in the z direction), for example, about 10-100 μm. Second section 1130 of the edge coupler may include a second portion 1134, which may have a constant width (e.g., the width of the waveguide, such as between about 0-5 μm) and may be a part of the waveguide. Second section 1130 may have a thickness that is greater than the thickness of first section 1120, such as about 5-150 nm (e.g., about 50 nm). As illustrated, second region 1124 of first section 1120 and first region 1132 of second section 1130 may taper in opposite directions, and may have an overlap region that is about, for example, 1-30 μm in the z direction. First section 1120 and second section 1130 may include the same material or different materials, and second section 1130 may be on top of first section 1120 and in contact with first section 1120.

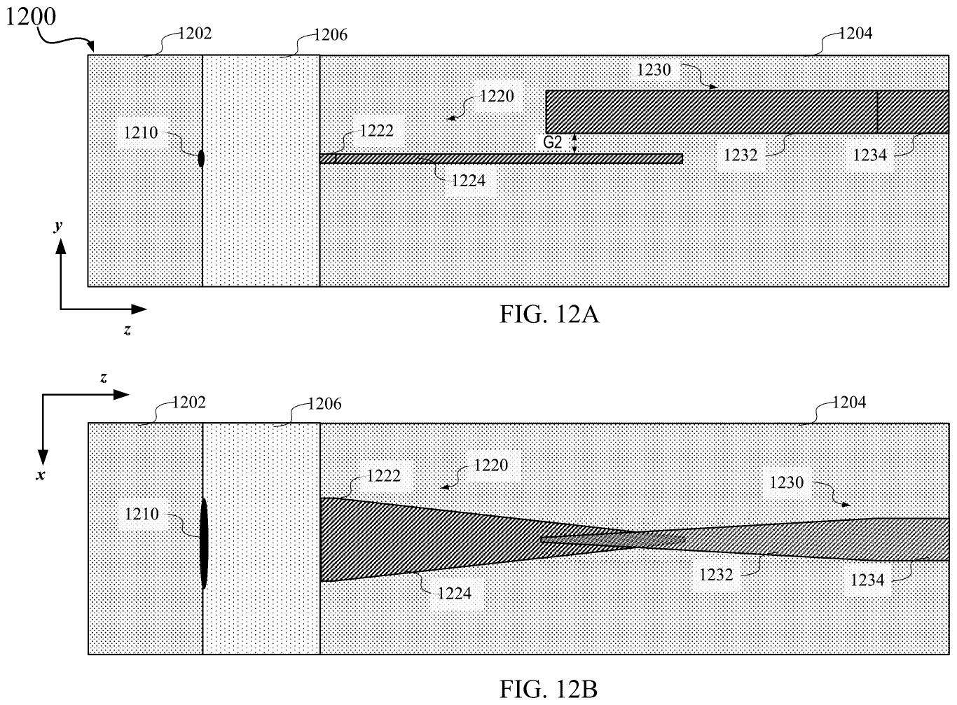

FIGS. 12A-12B illustrate yet another example of a device 1200 including an edge coupler for coupling light beam emitted by a laser into a waveguide of a photonic integrated circuit according to certain embodiments. FIG. 12A is a vertical cross-sectional view of device 1200, and FIG. 12B is a horizontal cross-sectional view of device 1200. Device 1200 may include a laser die 1202 that has a laser emission region 1210, where the emitted laser beam may have an elliptical shape. In the illustrated example, the beam width in the x direction may be much larger than the beam width in the y direction. Laser die 1202 may be in close proximity to PIC 1204, for example, with a distance equal to or less than about 10 μm in the z direction. The region between laser die 1202 and PIC 1204 may be filled with an index-matching material 1206 (e.g., SiO₂ or another dielectric material) that may have a refractive index greater than 1.0, such as greater than about 1.5 or higher, and thus may help to reduce Fresnel reflections at interfaces between different media. In some embodiments, the light emitting surface of laser die 1202 and edge surface of PIC 1204 may be coated with an ARC layer to further reduce losses caused by reflections.

PIC 1204 may include one or more waveguide core layers (e.g., including SiN cores) surrounded by cladding layers (e.g., including SiO₂) that have lower refractive indices than the waveguide cores. Both the waveguide core layers and the cladding layers may be substantially transparent to the laser beam emitted by laser die 1202, which may be visible light or invisible light, such as infrared light. In the illustrated example, PIC 1204 may include an edge coupler for coupling the laser beam into a waveguide. The edge coupler may include two sections, where the waveguide cores of the two sections may have different thicknesses (measured in the y direction) and may include oppositely tapered regions. The bottom surface of the second section may be at a distance above (in the y direction) the top surface of the first section, and the two sections may have some overlap in the z direction.

A first section 1220 of the edge coupler is at an edge of PIC 1204. First section 1220 may include a first region 1222 that have a constant width (e.g., about 1-10 μm measured in the x direction), and a second region 1224 the width of which may be gradually (linearly or nonlinearly) tapered down in the z direction. First region 1222 may have a low thickness, for example, about 5-30 nm, such as about 10 nm. Therefore, first region 1222 may have a large width-to-thickness ratio, such that it may better match the elliptical beam shape of the laser beam. First region 1222 may have a length (measured in the z direction), for example, about 0 to 20 μm. Second region 1224 may have a length, for example, about 5-50 μm. The end of second region 1224 of first section 1220 may have a width W3 about 0 to about 300 nm. First region 1222 and second region 1224 may have the same thickness, for example, about 5-30 nm, such as about 10 nm.

A second section 1230 of the edge coupler that couples to a waveguide of PIC 1204 may include a first region 1232, the width of which may be about 0-300 nm at the tip and may gradually increase in the z direction (tapered in the -z direction) to the width of the waveguide. First region 1232 of second section 1230 may have a length (measured in the z direction), for example, about 10-100 μm. Second section 1230 of the edge coupler may include a second portion 1234, which may have a constant width (e.g., the width of the waveguide, such as between about 0-5 μm) and may be a part of the waveguide. Second section 1230 may have a thickness that is greater than the thickness of first section 1220, such as about 5-150 nm (e.g., about 50 nm). As illustrated, second region 1224 of first section 1220 and first region 1232 of second section 1230 may taper in opposite directions, and may have an overlap region that is about, for example, 1-30 μm in the z direction. First section 1220 and second section 1230 may include the same material or different materials, and second section 1230 may be at a distance G2 (e.g., about 0-200 nm) above the top surface of first section 1220.

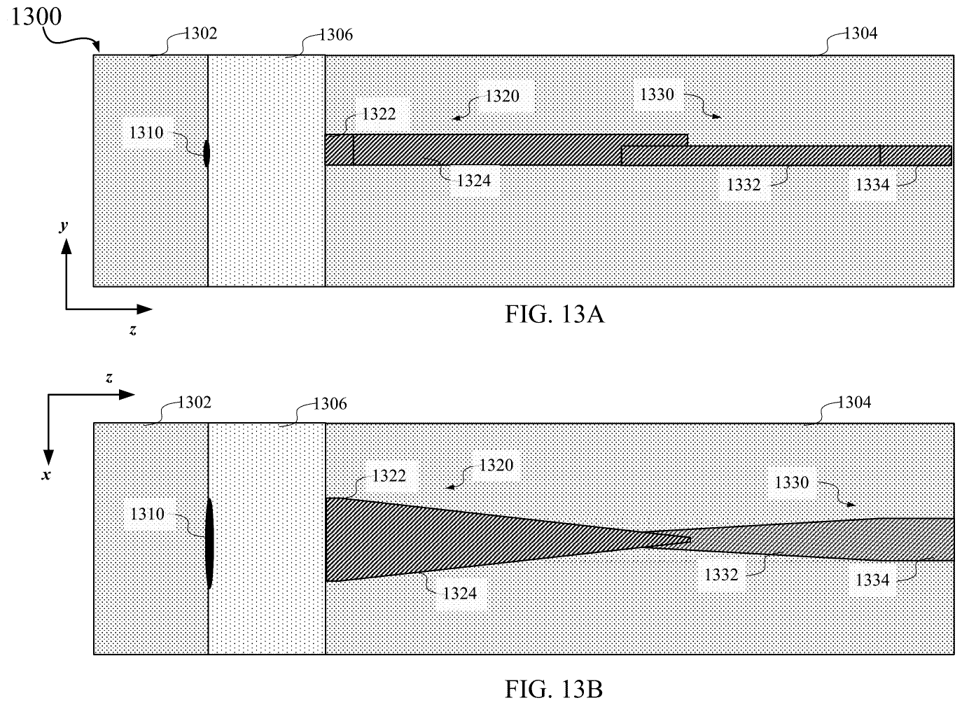

FIGS. 13A-13B illustrate another example of a device 1300 including an edge coupler for coupling light beam emitted by a laser into a waveguide of a photonic integrated circuit according to certain embodiments. FIG. 13A is a vertical cross-sectional view of device 1300, and FIG. 13B is a horizontal cross-sectional view of device 1300. Device 1300 may include a laser die 1302 that has a laser emission region 1310, where the emitted laser beam may have, for example, an elliptical shape. In the illustrated example, the beam width in the x direction may be much larger than the beam width in the y direction. Laser die 1302 may be in close proximity to PIC 1304. The region between laser die 1302 and PIC 1304 may be filled with an index-matching material 1306 (e.g., SiO₂ or another dielectric material) that may have a refractive index greater than 1.0, such as greater than about 1.5 or higher, and thus may help to reduce Fresnel reflections at interfaces between different media, such as the light emitting surface of laser die 1302 and the edge surface of PIC 1304. For example, index-matching material 1306 may reduce the reflection from about 5% to below 1% and reduce the insertion loss by 5%. In some embodiments, light emitting surfaces of laser die 1302 and edge surface of PIC 1304 may be coated with an ARC layer to further reduce losses caused by reflections.

PIC 1304 may include one or more waveguide core layers (e.g., including SiN cores) surrounded by cladding layers (e.g., including SiO2) that have lower refractive indices than the waveguide cores. Both the waveguide core layers and the cladding layers may be substantially transparent to the laser beam emitted by laser die 1302, which may be visible light or invisible light, such as infrared light. In the illustrated example, PIC 1304 may include an edge coupler for coupling the laser beam into a waveguide of PIC 1304. The edge coupler may include two sections, where the waveguide cores of the two sections may have different thicknesses (measured in the y direction) and may include oppositely tapered regions. The bottom surfaces (in y direction) of the two sections may be on a same plane (e.g., an x-z plane), and the two sections may have some overlap in the z direction (e.g., viewed in x or y direction).

A first section 1320 of the edge coupler is at an edge of PIC 1304. First section 1320 may have a first region 1322 that has a constant width in the x direction, and a second region 1324 the width of which may be gradually (linearly or nonlinearly) tapered down in the z direction. First region 1322 and second region 1324 may have the same thickness (or height), for example, about 5-150 nm, such as about 50 nm.

A second section 1330 of the edge coupler may couple to a waveguide of PIC 1304. Second section 1330 may include a first region 1332, the width of which may gradually increase in the z direction (tapered in the -z direction) to the width of the waveguide of PIC 1304. Second section 1330 of the edge coupler may include a second portion 1334, which may have a constant width and may be a part of the waveguide. Second section 1330 may have a thickness that is lower than the thickness of first section 1320, such as about 5-30 nm (e.g., about 10 nm). As illustrated, second region 1324 of first section 1320 and first region 1332 of second section 1330 may taper in opposite directions, and may have an overlap region. First section 1320 and second section 1330 may include the same or different material and may merge in the overlap region.

Even though the first section of the edge coupler is shown as below at least a portion of the second section of the edge coupler in the examples shown in FIG. 8A, 9A-9C, 11A, 11B, 12A, 12B, 13A, and 13B, in some embodiments, the first section of the edge coupler may be above at least a portion of the second section of the edge coupler.

The coupling efficiency of polarized laser emission with a wavelength about 450 nm to waveguides in PIC can be up to about 85-90% using the edge coupler disclosed herein, where the laser die and the PIC may have an air gap about lum in between, and the PIC waveguide is a SiN buried in SiO₂ Techniques disclosed herein can be used to coupler laser light in the visible wavelength range (e.g., between about 400-700 nm) or invisible wavelength range, by changing the dimensions of the layers.

Various materials can be used as the waveguide cores of the edge couplers. For example, the first section of the edge coupler with a lower thickness may include SiN, Al₂O₃, SiON, and the like. The second section of the edge coupler with a higher thickness may include SiN, LiNI, AlN, and the like. The dimensions of each taper and the overlap can be optimized to achieve the desired performance. Using the index-matching material may reduce the reflection from about 5% to below 1% and reduce the insertion loss by 5%, and may reduce some challenges associated with imperfect facets.

The edge coupler structure disclosed herein may have high tolerance of the relative position of the waveguides. For example, an offset about 150 nm from the desired location along the light propagation or longitudinal direction (e.g., the z direction) may cause less than about 1% additional insertion loss. An offset about 150 nm from the desired location in the horizontal direction (e.g., the x direction) may cause less than about 8% additional insertion loss. An offset about 100 nm from the desired location in the horizontal direction (e.g., the x direction) may cause less than about 4% additional insertion loss. The edge couplers disclosed herein can be used for passive and/or active alignment of laser dies with PICs, and can be compatible with self-aligning wafer-level laser to PIC bonding techniques such as flip-chip bonding.

Embodiments disclosed herein may be used to implement components of an artificial reality system or may be implemented in conjunction with an artificial reality system. Artificial reality is a form of reality that has been adjusted in some manner before presentation to a user, which may include, for example, a virtual reality, an augmented reality, a mixed reality, a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including an HMD connected to a host computer system, a standalone HMD, a mobile device or computing system, or any other hardware platform capable of providing artificial reality content to one or more viewers.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in

accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” may refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms “and” and “or,” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or any combination of A, B, and/or C, such as AB, AC, BC, AA, ABC, AAB, AABBCCC, or the like.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A device comprising:
a light source configured to emit a light beam; and
a photonic integrated circuit (PIC) including an edge coupler configured to couple the light beam into a waveguide of the PIC, the edge coupler comprising:
a first waveguide section characterized by a first thickness and a first constant width;
a second waveguide section coupled to the first waveguide section, the second waveguide section characterized by the first thickness and a gradually decreasing width; and
a third waveguide section partially overlapping with the second waveguide section at an overlap region, the third waveguide section characterized by a gradually increasing width and a second thickness different from the first thickness.

2. The device of claim 1, wherein a ratio between the first constant width and the first thickness is greater than 10.

3. The device of claim 1, wherein the second thickness is at least two times of the first thickness.

4. The device of claim 1, wherein:
a bottom surface of the second waveguide section and a bottom surface of the third waveguide section are on a same plane; and
the second waveguide section and the third waveguide section are merged in the overlap region.

5. The device of claim 1, wherein:
a top surface of the second waveguide section and a top surface of the third waveguide section are on a same plane; and
the second waveguide section and the third waveguide section are merged in the overlap region.

6. The device of claim 1, wherein a bottom surface of the second waveguide section and a top surface of the third waveguide section are on a same plane.

7. The device of claim 1, wherein a top surface of the second waveguide section and a bottom surface of the third waveguide section are on a same plane.

8. The device of claim 1, wherein a distance between the second waveguide section and the third waveguide section is between 0 and 200 nm at the overlap region.

9. The device of claim 1, wherein:
the first thickness is between 5 nm and 30 nm; and
the first constant width is between 1 μm and 10 μm.

10. The device of claim 1, wherein the overlap region is characterized by a length between 1 μm and 30 μm.

11. The device of claim 1, wherein the second waveguide section is characterized by a minimum width at or below 300 nm.

12. The device of claim 1, wherein the third waveguide section is characterized by a minimum width at or below 300 nm.

13. The device of claim 1, wherein the second thickness is between 5 nm and 150 nm.

14. The device of claim 1, further comprising a fourth waveguide section coupled to the third waveguide section, the fourth waveguide section characterized by the second thickness and a second constant width.

15. The device of claim 14, wherein a ratio between the second constant width and the second thickness is less than 2000.

16. The device of claim 1, further comprising a refractive index matching material between the light source and the PIC.

17. A waveguide coupler comprising:
a first waveguide section characterized by a first thickness and a first constant width;
a second waveguide section physically coupled to the first waveguide section, the second waveguide section characterized by the first thickness and a gradually decreasing width; and
a third waveguide section partially overlapping with the second waveguide section at an overlap region, the third waveguide section characterized by a gradually increasing width and a second thickness different from the first thickness,
wherein a surface of the second waveguide section and a surface of the third waveguide section are on a same plane.

18. The waveguide coupler of claim 17, wherein a ratio between the first constant width and the first thickness is greater than 10.

19. The waveguide coupler of claim 17, wherein:
the surface of the second waveguide section is a top surface or a bottom surface of the second waveguide section; and
the surface of the third waveguide section is a top surface or a bottom surface of the third waveguide section. cm 20. A waveguide coupler comprising:
a first waveguide section characterized by a first thickness and a first constant width, wherein the first constant width is greater than 10 times of the first thickness;
a second waveguide section physically coupled to the first waveguide section, the second waveguide section characterized by the first thickness and a gradually decreasing width; and
a third waveguide section partially overlapping with the second waveguide section at an overlap region, the third waveguide section characterized by a gradually increasing width and a second thickness different from the first thickness.
